(19) United States
(12) Patent Application Publication
(10) Pub. No.: US 2026/0177990 A1
(43) Pub. Date: Jun. 25, 2026

(54) Alert Wristband Device

(71) Applicant: Stefenie Rustige, Dittmer, MO (US)

(72) Inventor: Stefenie Rustige, Dittmer, MO (US)

(21) Appl. No.: 19/207,454

(22) Filed: May 14, 2025

Related U.S. Application Data
(60) Provisional application No. 63/736,004, filed on Dec. 19, 2024.

(51) Int. Cl. G04G 13/02; G04C 21/34

(52) U.S. Cl. CPC G04G 13/021; G04C 21/34

(57) ABSTRACT

An alert wristband device is disclosed, which is a modified wristband device with an alert system. The alert wristband device comprises a housing component that is configured in a rectangular shape, slim face secured to a wristband component. The housing component comprises a mode button to switch from a haptic vibration to a light signal. Both the haptic and light modes would be discreet so only the user will be alerted of the notification. The wristband is also preferably waterproof and manufactured from a hypoallergenic silicone. The device may be any size, color and design based upon the preference of a user. When in use, the device will remind the user that it is time to meet a group or may be used to remind a user to take medication, of an activity, etc.

### CROSS-REFERENCE TO RELATED APPLICATION

The present application claims priority to, and the benefit of, U.S. Provisional Application No. 63/736,004, which was filed on Dec. 19, 2024, and is incorporated herein by reference in its entirety.

### FIELD OF THE INVENTION

The present invention relates generally to the field of alert wristband devices. More specifically, the present invention relates to an alert wristband with a discreet vibration or light alerts, which allows a group of individuals to receive notifications at the same time. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in alert wristband devices. Generally, groups of individuals often make plans to meet at the same time. However, if someone loses track of the time and is late, it can ruin the experience for the whole group. This is both frustrating and undesirable.

Family gatherings and friend trips can be fun bonding experiences but trying to keep a big group together and on time can quickly replace delight with frustration. Thus, a need exists for an easy way to let people know its time to gather at their meeting place, whether the group is getting ready to meet up for lunch, attend an event, head home, etc.

Accordingly, there is a demand for an improved alert wristband device that has both haptic vibration and silent light modes, making it adaptable to a variety of environments and situations. More particularly, there is a demand for an alert wristband device that is a convenient and discreet notification device and that can also send a signal to an emergency contact when an S.O.S. button is pushed.

Therefore, there exists a long felt need in the art for an alert wristband device that provides users with a discreet vibration or light alert. There is also a long felt need in the art for an alert wristband device that allows a group of individuals to receive notifications at the same time. Further, there is a long felt need in the art for an alert wristband device that features a waterproof band and manufactured from a hypoallergenic silicone. Moreover, there is a long felt need in the art for a device that includes a one-size-fits-all band and a mode button. Further, there is a long felt need in the art for an alert wristband device that can be any suitable size, color, and design based upon the preference of a user. Finally, there is a long felt need in the art for an alert wristband device that includes an S.O.S. feature that pings an emergency contact and sends location and functions as a tracker for hikers, skiers, campers, or anyone else who might get lost.

The subject matter disclosed and claimed herein, in one embodiment thereof, comprises an alert wristband device. The device is a modified wristband device with an alert system. The alert wristband device comprises a housing component that is configured in a rectangular shape, slim face secured to a wristband component. The housing component comprises a mode button to switch from a haptic vibration to a light signal. Both the haptic and light modes would be discreet so only the user will be alerted of the notification. The wristband is also preferably waterproof and manufactured from a hypoallergenic silicone. The device may be any size, color and design based upon the preference of a user. When in use, the device will remind the user that it is time to meet a group or may be used to remind a user to take medication, of an activity, etc.

In this manner, the alert wristband device of the present invention accomplishes all of the forgoing objectives and provides users with a device that discreetly reminds a group of individuals of meetings, events, and other get togethers. The device is a wristband with a housing component comprising an alert system for discreetly alerting others. The device can be any suitable size, color and design.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an alert wristband device. The device is a modified wristband device with an alert system. The alert wristband device comprises a housing component secured to a wristband component. The housing component comprises a mode button to switch from a haptic vibration to a light signal. Both the haptic and light modes would be discreet so only the user will be alerted of the notification. When in use, the device will remind the user that it is time to meet a group or may be used to remind a user to take medication, of an activity, etc.

In one embodiment, the alert wristband device is utilized for a variety of alerts, such as medication reminders, school or activity pickups, etc. The device has both haptic vibration and silent light alerts, making it adaptable to a variety of environments and situations. The alert wristband device is great for situations where phones are not practical, including crowded environments, such as amusement parks, water parks, museums, malls, cruise ships, etc.

In one embodiment, the alert wristband device comprises a housing component that is configured in a rectangular shape. However, any suitable shape can be utilized as well, such as oval, square, circular, etc., depending on the needs and/or wants of a user. Typically, the housing component is slim faced but can be any suitable shape and size as is known in the art, as long as the housing component is shaped and sized to house the needed components and circuitry for the device to function. Further, the housing component is available in multiple sizes, depending on the size of the user wearing it, and they're wants and/or needs.

In one embodiment the housing component includes a display screen that is similar to a wristwatch. The display screen is typically an LCD screen or other suitable screen as is known in the art. The display screen displays information to the user, such as the current time, device settings, or any notifications. The display screen can also be illuminated when a light signal alert is sent.

In one embodiment, the housing component is secured to a wristband component. The wristband component can be manufactured of any suitable material as is known in the art. Preferably, the wristband component is waterproof and manufactured from a hypoallergenic silicone, but can also be made of metal, such as stainless steel or aluminum, or any other suitable urethanes or plastics, etc. Further, the wristband component is secured around a user's wrist via a securing means, such as hook and loop fasteners, snaps, loop and pile fasteners, etc. Thus, the wristband component is wrapped around a user's wrist and secured, with the housing component positioned on the exterior of a user's wrist. The wristband component is a one-size-fits-all band.

In one embodiment, the housing component comprises a plurality of components, such as but not limited to, a processor, a timer, at least one LED light, a haptic vibration component for producing vibrations, and a GPS component for tracking. The component can be connected to each other and to the display screen by any suitable means including, but not limited to, wires running through the housing component. Communication between the components and the display screen may also be provided by any suitable wireless method as is known in the art.

In one embodiment, the alert wristband device is used to alert users of specific meeting times, medication reminders, school or activity pickups, etc., via sending discreet alerts, such as haptic vibrations and/or light signal alerts. Users would program meeting times, medication reminders, and/or school or activity functions/pickups into the processor via the housing component. When the time for the functions occurs, the processor sends discreet alerts to a user (i.e., wearer of the device). Specifically, the haptic vibration component is typically positioned adjacent to a user's wrist, when the device is being worn by the user. The at least one LED lights are positioned around the housing component and illuminate with the display screen when a light signal alert is sent. Further, the housing component comprises a mode button to switch from a haptic vibration to a light signal alert, as needed. Specifically, a user taps once on the mode button for haptic vibrations and taps twice on the mode button for light signal alerts. Both the haptic and light modes would be discreet so only the user will be alerted of the notifications.

In one embodiment, the housing component comprises a graphical user interface (GUI) or other control component for programming meeting times, medication, reminders, and/or school or activity functions/pickups. Further, besides a mode button for switching from haptic vibrations to light signal alerts, the housing component comprises an on/off button and a settings button to allow a user to navigate from displaying the time on the display screen to programming meeting times and school pickups. Any combination of buttons or other control components to change the settings or navigate the GUI on the display screen may be used, and the device is not limited to this particular embodiment.

In one embodiment, the housing component comprises an S.O.S. button. The S.O.S. button is activated in case of emergencies and when pressed, alerts (pings) a designated emergency contact. When this button is pressed, the GPS component is activated, allowing the device to be tracked and sends location information upon request. Thus, the device can function as a tracker for hikers, skiers, campers, or anyone else who might get lost.

In one embodiment, the housing component comprises a battery component. The battery component can be a replaceable or rechargeable battery. If replaceable, the battery component is removed and replaced, as needed. If rechargeable, the housing component further comprises a charge port for charging the battery component, as needed. An electrical cord would be plugged into the charge port and then into an electrical outlet to charge the battery component.

In one embodiment, the alert wristband device is preferably wearable so that it can be carried with the user at all times. In most embodiments, it is shown being worn on a user's wrist, but it is not limited to this particular embodiment.

In one embodiment, the alert wristband device is available in multiple colors and fun designs depending on the needs and/or wants of a user.

In one embodiment, the housing component includes a wireless communications module and additional sensors which would allow the alert wristband device to pair with a mobile application on a smart device. Once paired, a user could program and control the alert wristband device via the mobile application.

In yet another embodiment, the alert wristband device comprises a plurality of indicia.

In yet another embodiment, a method of discreetly notifying a user of various events is disclosed. The method includes the steps of providing an alert wristband device comprising a housing component secured to a wristband component. The method also comprises securing the wristband component around a user's wrist. Further, the method comprises programming the housing component to alert a user at predetermined times. The method also comprises alerting a user via haptic vibrations or light signal alerts. Finally, the method comprises alerting an emergency contact via the S.O.S. button.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the alert wristband device of the present invention in accordance with the disclosed architecture;

FIG. 2 illustrates a perspective view of one embodiment of the alert wristband device of the present invention showing the light alert in accordance with the disclosed architecture;

FIG. 3 illustrates a perspective view of one embodiment of the alert wristband device of the present invention showing the haptic vibration alert in accordance with the disclosed architecture;

FIG. 4 illustrates a perspective view of one embodiment of the alert wristband device of the present invention showing the mode button and emergency button in accordance with the disclosed architecture;

FIG. 5 illustrates a perspective view of one embodiment of the alert wristband device of the present invention showing the wristband component in accordance with the disclosed architecture;

FIGS. 6A-B illustrate a perspective view of one embodiment of the alert wristband device of the present invention showing the device and its components in accordance with the disclosed architecture;

FIGS. 7A-C illustrate a perspective view of one embodiment of the alert wristband device of the present invention showing the device in use in accordance with the disclosed architecture; and

FIG. 8 illustrates a flowchart showing the method of discreetly notifying a user of various events in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an alert wristband device that provides users with a discreet vibration or light alert. There is also a long felt need in the art for an alert wristband device that allows a group of individuals to receive notifications at the same time. Further, there is a long felt need in the art for an alert wristband device that features a waterproof band and manufactured from a hypoallergenic silicone. Moreover, there is a long felt need in the art for a device that includes a one-size-fits-all band and a mode button. Further, there is a long felt need in the art for an alert wristband device that can be any suitable size, color, and design based upon the preference of a user. Finally, there is a long felt need in the art for an alert wristband device that includes an S.O.S. feature that pings an emergency contact and sends location and functions as a tracker for hikers, skiers, campers, or anyone else who might get lost.

The present invention, in one exemplary embodiment, is a novel alert wristband device. The alert wristband device comprises a housing component that is configured in a rectangular shape, slim face secured to a wristband component. The housing component comprises a mode button to switch from a haptic vibration to a light signal. Both the haptic and light modes would be discreet so only the user will be alerted of the notification. The wristband is also preferably waterproof and manufactured from a hypoallergenic silicone. The device may be any size, color and design based upon the preference of a user. When in use, the device will remind the user that it is time to meet a group or may be used to remind a user to take medication, of an activity, etc.

The present invention also includes a novel method of discreetly notifying a user of various events. The method includes the steps of providing an alert wristband device comprising a housing component secured to a wristband component. The method also comprises securing the wristband component around a user's wrist. Further, the method comprises programming the housing component to alert a user at predetermined times. The method also comprises alerting a user via haptic vibrations or light signal alerts. Finally, the method comprises alerting an emergency contact via the S.O.S. button.

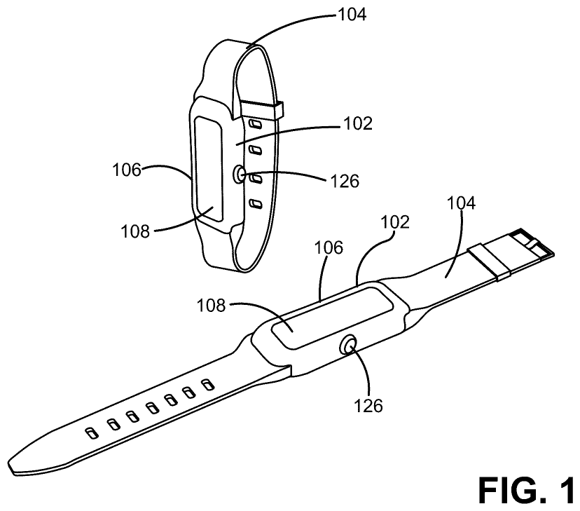

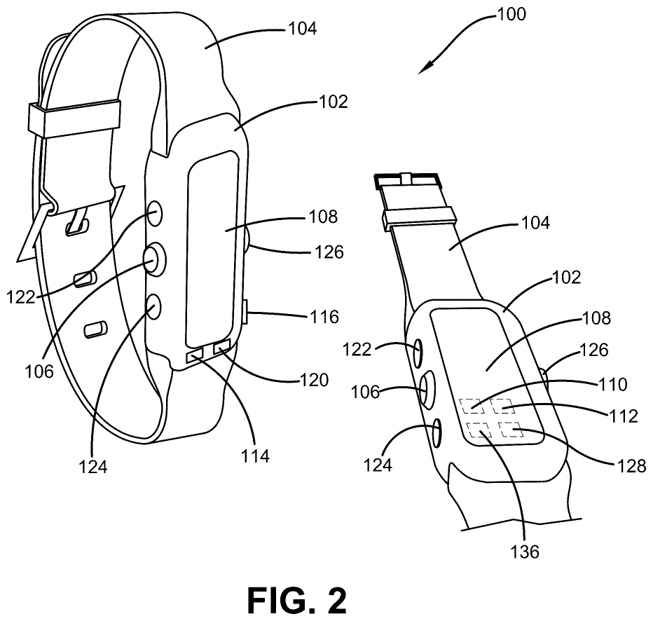

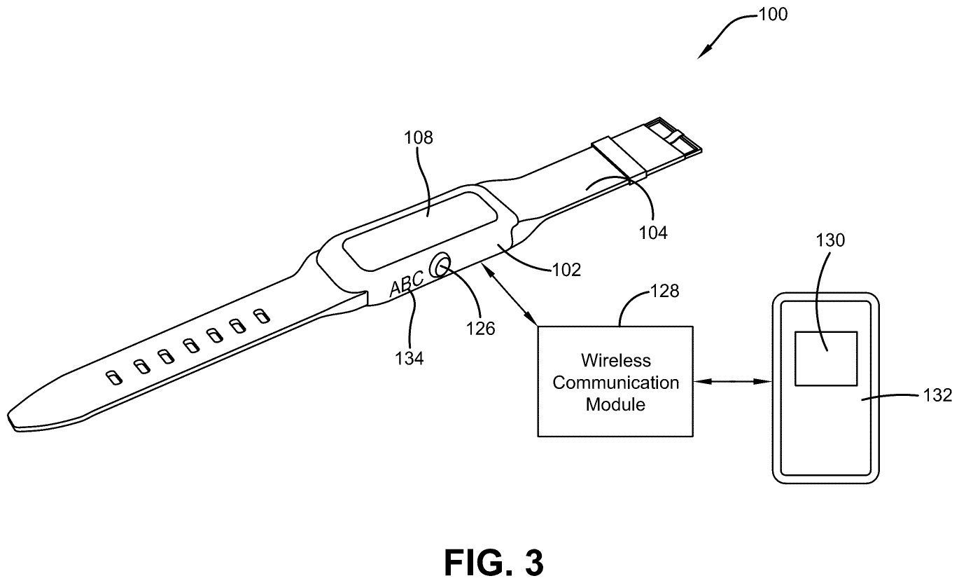

Referring initially to the drawings, FIGS. 1-3 illustrate a perspective view of one embodiment of the alert wristband device 100 of the present invention. In the present embodiment, the alert wristband device 100 is an improved alert wristband device 100 that provides a user with discreet alerts for reminders. Specifically, the alert wristband device 100 comprises a housing component 102 attached to a wristband component 104. The housing component 102 comprises a mode button 106 to switch from a haptic vibration to a light signal. Both the haptic and light modes would be discreet so only the user will be alerted of the notification. When in use, the device 100 will remind the user that it is time to meet a group or may be used to remind a user to take medication, go to an activity, etc.

Generally, the alert wristband device 100 is utilized for a variety of alerts, such as medication reminders, school or activity pickups, etc. The device 100 has both haptic vibration and silent light alerts, making it adaptable to a variety of environments and situations. The alert wristband device 100 is great for situations where phones are not practical, including crowded environments, such as amusement parks, water parks, museums, malls, cruise ships, etc.

Further, the alert wristband device 100 comprises a housing component 102 that is configured in a rectangular shape. However, any suitable shape can be utilized as well, such as oval, square, circular, etc., depending on the needs and/or wants of a user. Typically, the housing component 102 is slim faced, but can be any suitable shape and size as is known in the art, as long as the housing component 102 is shaped and sized to house the needed components and circuitry for the device 100 to function. Further, the housing component 102 is available in multiple sizes, depending on the size of the user wearing it, and they're wants and/or needs.

Additionally, the housing component 102 includes a display screen 108 that is similar to a wristwatch. The display screen 108 is typically an LCD screen or other suitable screen as is known in the art. The display screen 108 displays information to the user, such as the current time, device settings, or any notifications. The display screen 108 can also be illuminated when a light signal alert is sent.

Furthermore, the housing component 102 is secured to a wristband component 104. The wristband component 104 can be manufactured of any suitable material as is known in the art. Preferably, the wristband component 104 is waterproof and manufactured from a hypoallergenic silicone, but can also be made of metal, such as stainless steel or aluminum, or any other suitable urethanes or plastics as is known in the art, etc. Further, the wristband component 104 is secured around a user's wrist via a securing means 110, such as hook and loop fasteners, snaps, loop and pile fasteners, etc. Thus, the wristband component 104 is wrapped around a user's wrist and secured, with the housing component 102 positioned on the exterior of a user's wrist. The wristband component 104 is a one-size-fits-all band.

Generally, the wristband component 104 is also manufactured from a material that is water resistant or waterproof or comprises a coating that is water resistant or waterproof. Furthermore, the device can be made of antibacterial or antimicrobial material or comprises a coating that is antibacterial or antimicrobial.

Typically, the housing component 102 comprises a plurality of components, such as but not limited to, a processor 110, a timer 112, at least one LED light 114, a haptic vibration component 116 for producing vibrations, and a GPS component 118 for tracking. The components can be connected to each other and to the display screen 108 by any suitable means including, but not limited to, wires running through the housing component 102. Communication between the components and the display screen 108 may also be provided by any suitable wireless method as is known in the art.

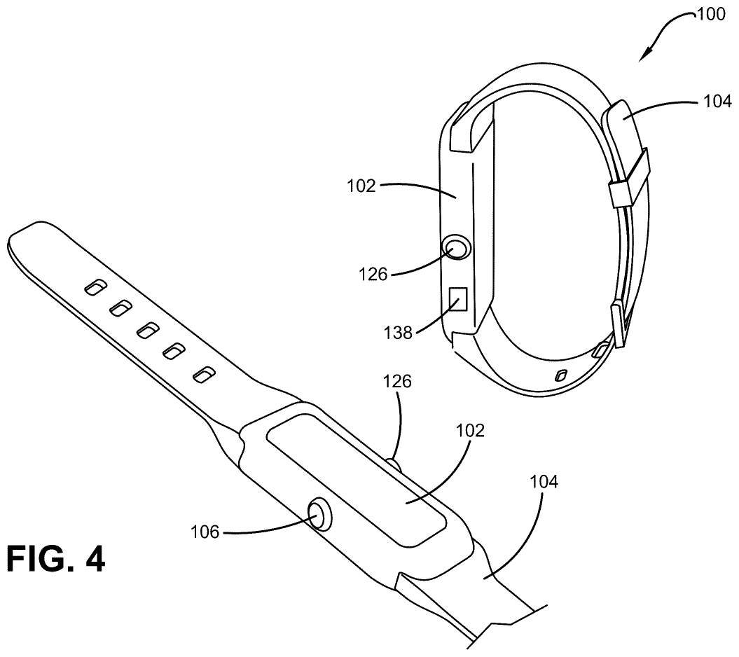

As shown in FIG. 4, the alert wristband device 100 is used to alert users of specific meeting times, medication reminders, school or activity pickups, etc., via sending discreet alerts, such as haptic vibrations and/or light signal alerts. Users would program meeting times, medication reminders, and/or school or activity functions/pickups into the processor 110 via the housing component 102. When the time for the functions occurs, the processor 110 sends discreet alerts to a user (i.e., wearer of the device 100). Specifically, the haptic vibration component 116 is typically positioned adjacent to a user's wrist, when the device 100 is being worn by the user. The at least one LED lights 114 are positioned around the housing component 102 and illuminate with the display screen 108 when a light signal alert is sent. Further, the housing component 102 comprises a mode button 106 to switch from a haptic vibration to a light signal alert, as needed. Specifically, a user taps once on the mode button 106 for haptic vibrations and taps twice on the mode button 106 for light signal alerts. Both the haptic and light modes would be discreet so only the user will be alerted of the notifications.

Further, the housing component 102 comprises a graphical user interface (GUI) 120 or other control component for programming meeting times, medication, reminders, and/or school or activity functions/pickups. Further, besides a mode button 106 for switching from haptic vibrations to light signal alerts, the housing component 102 comprises an on/off button 122 and a settings button 124 to allow a user to navigate from displaying the time on the display screen 108 to programming meeting times and school pickups. Any combination of buttons or other control components to change the settings or navigate the GUI 120 on the display screen 108 may be used, and the device 100 is not limited to this particular embodiment.

Additionally, the housing component 102 comprises an S.O.S. button 126. The S.O.S. button 126 is activated in case of emergencies and when pressed, alerts (pings) a designated emergency contact. When this button 126 is pressed, the GPS component 118 is activated, allowing the device 100 to be tracked and sends location information upon request. Thus, the device 100 can function as a tracker for hikers, skiers, campers, or anyone else who might get lost.

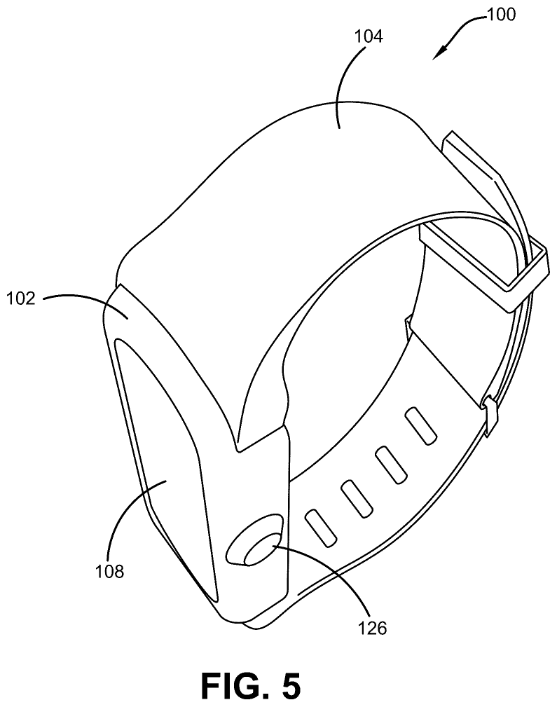

As shown in FIG. 5, in one embodiment, the housing component 102 includes a wireless communications module 128 and additional sensors which would allow the alert wristband device 100 to pair with a mobile application 130 on a smart device 132. Once paired, a user could program and control the alert wristband device 100 via the mobile application 130. Typically, the wireless communications module 128 performs any type of wireless communication, including, but not limited to, WIFI, BLUETOOTH, RFID, NFC, etc.

In yet another embodiment, the alert wristband device 100 comprises a plurality of indicia 134. The housing component 102 of the device 100 may include advertising, a trademark, or other letters, designs, or characters, printed, painted, stamped, or integrated into the housing component 102, or any other indicia 134 as is known in the art. Specifically, any suitable indicia 134 as is known in the art can be included, such as but not limited to, patterns, logos, emblems, images, symbols, designs, letters, words, characters, animals, advertisements, brands, etc., that may or may not be alert, wristband, or brand related.

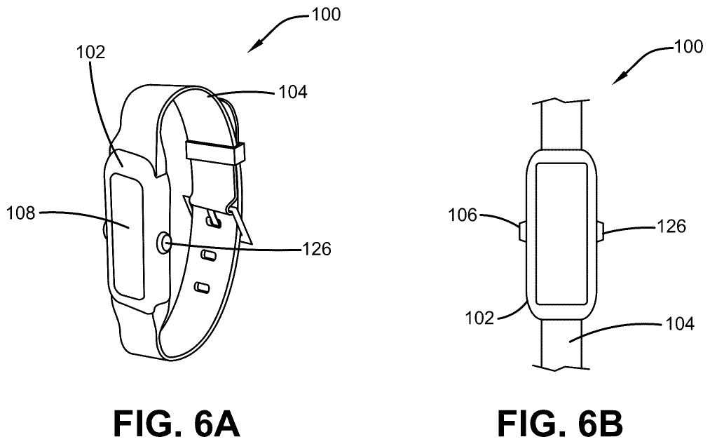

As shown in FIGS. 6A-B, the housing component 102 comprises a battery component 136. The battery component 136 can be a replaceable or rechargeable battery. If replaceable, the battery component 136 is removed and replaced, as needed. If rechargeable, the housing component 102 further comprises a charge port 138 for charging the battery component 136, as needed. An electrical cord would be plugged into the charge port 138 and then into an electrical outlet to charge the battery component 136.

Specifically, the battery component 136 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the alert wristband device 100. Throughout this specification, the term “battery” may be used interchangeably to refer to one or more wet or dry cells or batteries of cells in which chemical energy is converted into electricity and used as a source of DC power. References to recharging or replacing the battery 136 may refer to recharging or replacing individual cells, individual batteries of cells, or a package of multiple battery cells as is appropriate for any given battery technology that may be used. In addition, a rechargeable embodiment of the battery 136 may be recharged using a USB port 138, wherein the USB port 138 is a USB-A, USB-B, Micro-B, Micro-USB, Mini-USB, or USB-C port, etc.

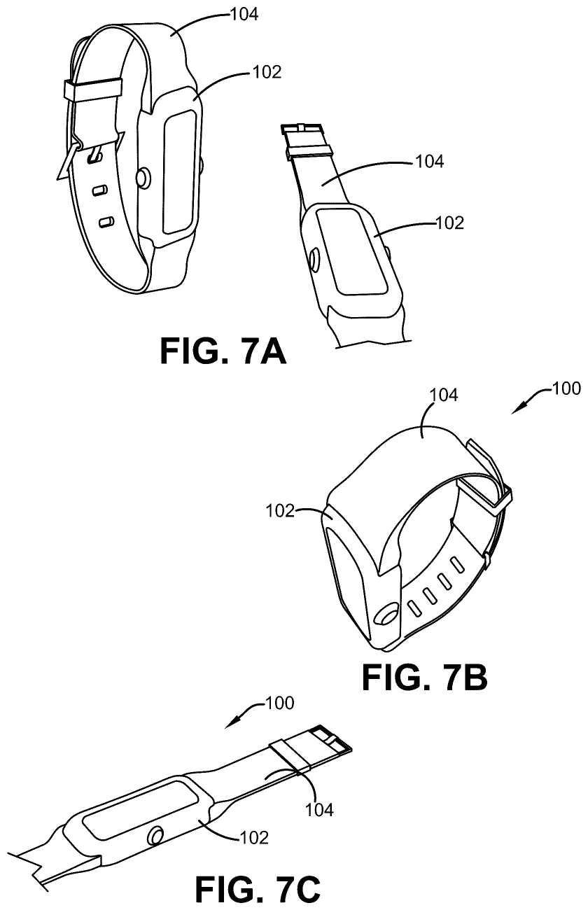

As shown in FIGS. 7A-C, the alert wristband device 100 is preferably wearable so that it can be carried with the user at all times. In most embodiments, it is shown being worn on a user's wrist, but it is not limited to this particular embodiment.

Further, the alert wristband device 100 is available in multiple colors and fun designs depending on the needs and/or wants of a user. Specifically, the device 100 may be made of molded plastic with any desirable decorative or ornamental designs and colors as is known in the art, depending on the needs and/or wants of a user.

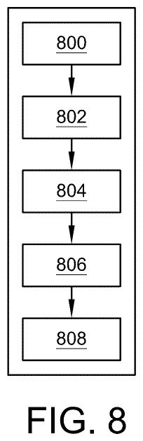

FIG. 8 illustrates a flowchart of the method of discreetly notifying a user of various events. The method includes the steps of at 800, providing an alert wristband device comprising a housing component secured to a wristband component. The method also comprises at 802, securing the wristband component around a user's wrist. Further, the method comprises at 804, programming the housing component to alert a user at predetermined times. The method also comprises at 806, alerting a user via haptic vibrations or light signal alerts. Finally, the method comprises at 808, alerting an emergency contact via the S.O.S. button.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “alert wristband device”, “alert device”, “wristband device”, and “device” are interchangeable and refer to the alert wristband device 100 of the present invention.

Notwithstanding the forgoing, the alert wristband device 100 of the present invention can be of any suitable size and configuration as is known in the art without affecting the overall concept of the invention, provided that it accomplishes the above stated objectives. One of ordinary skill in the art will appreciate that the alert wristband device 100 as shown in FIGS. 1-8 is for illustrative purposes only, and that many other sizes and shapes of the alert wristband device 100 are well within the scope of the present disclosure. Although the dimensions of the alert wristband device 100 are important design parameters for user convenience, the alert wristband device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An alert wristband device that provides a user with discreet alerts for reminders, the alert wristband device comprising:
a housing component; and
a wristband component;
wherein the housing component is secured to the wristband component, such that the wristband component is secured around a user's wrist with the housing component positioned on an exterior of a user's wrist; and
further wherein the housing component discreetly alerts a user of meetings, reminders, activities, and pick-ups via haptic vibrations or a light signal alert.

2. The alert wristband device of claim 1, wherein the housing component is configured in a rectangular shape.

3. The alert wristband device of claim 2, wherein the housing component includes a display screen for displaying current time, device settings, or any notifications.

4. The alert wristband device of claim 3, wherein the wristband component is waterproof and manufactured from a hypoallergenic silicone.

5. The alert wristband device of claim 4, wherein the housing component comprises a plurality of components, such as a processor, a timer, at least one LED light, a haptic vibration component for producing vibrations, and a GPS component for tracking.

6. The alert wristband device of claim 5, wherein users would program meeting times, medication reminders, or school or activity functions or pickups into the processor.

7. The alert wristband device of claim 6, wherein when time for meeting times, medication reminders, functions or pickups occurs, the processor sends discreet alerts to a user.

8. The alert wristband device of claim 7, wherein the light signal alert is the at least one LED light and the display screen being illuminated.

9. The alert wristband device of claim 8, wherein the haptic vibrations are vibrations produced from the haptic vibration component.

10. The alert wristband device of claim 9, wherein the housing component comprises a mode button to switch from a haptic vibration to a light signal alert, as needed.

11. The alert wristband device of claim 10, wherein the housing component comprises a graphical user interface (GUI) for programming meeting times, medication, reminders, or school or activity functions or pickups.

12. An alert wristband device that provides a user with discreet alerts for reminders, the alert wristband device comprising:
a housing component configured in a rectangular shape and comprising a display screen; and
a wristband component; and
wherein the housing component is secured to the wristband component, such that the wristband component is secured around a user's wrist with the housing component positioned on an exterior of a user's wrist;
wherein the housing component comprises a plurality of components, such as a processor, a timer, at least one LED light, a haptic vibration component for producing vibrations, and a GPS component for tracking;
wherein users would program meeting times, medication reminders, or school or activity functions or pickups into the processor;
wherein when time for meeting times, medication reminders, functions or pickups occurs, the processor sends discreet alerts to a user via haptic vibrations or a light signal alert;
wherein the light signal alert is the at least one LED light and the display screen being illuminated;
wherein the haptic vibrations are vibrations produced from the haptic vibration component; and
further wherein the housing component comprises a mode button to switch from a haptic vibration to a light signal alert, as needed.

13. The alert wristband device of claim 12, wherein the housing component comprises an on/off button.

14. The alert wristband device of claim 12, wherein the housing component comprises a settings button to allow a user to navigate from displaying time on the display screen to programming meeting times and school pickups.

15. The alert wristband device of claim 12, wherein the housing component comprises an S.O.S. button which is activated in case of emergencies and when pressed, alerts a designated emergency contact and allows for tracking via the GPS component.

16. The alert wristband device of claim 12, wherein the housing component includes a wireless communications module which would allow the alert wristband device to pair with a mobile application on a smart device, wherein once paired, a user could program and control the alert wristband device via the mobile application.

17. The alert wristband device of claim 12 further comprising a plurality of indicia.

18. The alert wristband device of claim 12, wherein the housing component comprises a battery component that is replaceable or rechargeable via a charge port.

19. The alert wristband device of claim 12, wherein the alert wristband device is available in multiple colors, designs, and sizes.

20. A method of discreetly notifying a user of various events, the method comprising the following steps:
providing an alert wristband device comprising a housing component secured to a wristband component;
securing the wristband component around a user's wrist;
programming the housing component to alert a user at predetermined times;
alerting a user via haptic vibrations or light signal alerts; and
alerting an emergency contact via the S.O.S. button.
